(19) United States
(12) Patent Application Publication
(10) Pub. No.: US 2013/0064034 A1
(43) Pub. Date: Mar. 14, 2013

(54) CYLINDRICAL PISTON ASSISTED BLENDING VESSEL

(71) Applicants: Robert Almblad, Tarpons Springs, FL (US); Susan Clickner, Tarpons Springs, FL (US)

(72) Inventors: Robert Almblad, Tarpons Springs, FL (US); Susan Clickner, Tarpons Springs, FL (US)

(21) Appl. No.: 13/500,419

(22) PCT Filed: Dec. 11, 2009
(86) PCT No.: PCT/US2009/067646

§ 371 Date: Nov. 26, 2012

Related U.S. Application Data
(60) Provisional application No. 61/249,356, filed on Oct. 7, 2009.

(51) Int. Cl. B01F 7/00

(52) U.S. Cl. 366/205

(57) ABSTRACT

A system for blending and dispensing a frozen mixture includes a blending chamber to receive the ingredients to be blended and a blending mechanism that includes a rotating blade for blending and a motor to drive the blade. A piston is located within the blending chamber, and a dispensing mechanism dispenses a blended mixture from the blending chamber. A discharge mechanism discharges a cleaning fluid from the blending chamber. The piston is moved to a first position with respect to the blending mechanism during a blending cycle and moved to a second position during a dispensing cycle, the second position being closer to the blending mechanism than the first position. The piston is moved to a third position with respect to the blending mechanism during an introduction of a cleaning fluid into the blending chamber, the third position being farther away from the blending mechanism than the first position. The piston is moved to a fourth position with respect to the blending mechanism during a discharging of the cleaning fluid cycle.

### PRIORITY INFORMATION

The present application claims priority, under 35 U.S.C. §119(e), from U.S. Provisional Patent Application, Ser. No. 61/249,356, filed on Oct. 7, 2009. The entire content of U.S. Provisional Patent Application, Ser. No. 61/249,356, filed on Oct. 7, 2009, is hereby incorporated by reference.

### TECHNICAL FIELD

The present invention is directed to a system for blending and dispensing a frozen mixture includes a blending chamber to receive the ingredients to be blended and a blending mechanism that includes a rotating blade for blending and a motor to drive the blade. More particularly, the present invention is directed to a system for blending and dispensing a frozen mixture wherein the blending chamber is clean in place, without removal from the blending system.

### BACKGROUND ART

Conventional blenders, commercial and consumer, perform the function of blending ingredients with a high speed blade, located at the bottom of a removable pitcher. This pitcher is removable from the motor stand in order to evacuate the ingredients by pouring out the ingredients.

To clean the blender, the pitcher and blade combination are washed without exposing the motor to the moisture. This usually entails the removal of the pitcher and blade from the blender mechanism and washing the combination in a sink, a dishwasher, or at a washing station. It is also noted that the blending process can be used during the cleaning process, but the pitcher and blade combination still need to be removed from the blender mechanism so to remove the dirty cleaning liquid from the pitcher.

In a commercial setting, where the blender is used to create drinks for immediate consumption by customers, this conventional method of blending and cleaning can take an undesirable amount of time.

For example, such a conventional process of blending/serve/cleaning may take from two to five minutes per drink. If only a single drink can be produce from this process, it could take up to fifty minutes to serve ten people. Such a wait may be acceptable at a sit down eating/drinking establishment; however, such a time period is not acceptable for quick service establishments.

In an attempt to speed up this process, a conventional solution has utilized a blender with a high speed blade at the bottom of a pitcher and an ice shaver above the pitcher. The ice shaver quickly shaves ice into the pitcher making it easier to blend the shaved ice and any ingredients in the blender. After blending the ice shaving and ingredient mixture, the pitcher is manually removed from the motor-stand and the blended product is poured from the pitcher into a serving container. The removed pitcher and blade combination are then washed in a sink and replaced on the motor stand for the next drink. This solution speeds up the process, but the solution is more expensive.

In addition, utilizing this conventional solution, the evacuation from the pitcher can be difficult, because after the drink is blended, the drink is very viscous and the contents tend to stick on the side walls of the pitcher. The viscous nature of the drink makes it difficult to empty the drink into a serving container (cup) without shaking, vibrating, and/or bouncing of the pitcher and blade combination. After the pitcher is evacuated as best as can be done by hand, the pitcher needs to be washed before making the next drink.

The washing usually takes longer because so much material sticks to the bottom and walls of the pitcher. In addition, tremendous waste is realized during the cleaning process.

An example of this solution is disclosed in U.S. Pat. No. 4,745,773. The entire content of U.S. Pat. No. 4,745,773 is hereby incorporated by reference.

In another conventional blender system, metering the ingredients, as the ingredients are put into a pitcher of a blender, is controlled by the use of a weight sensor under the pitcher. In this conventional system, the blender system includes a pitcher that is removable and has some type of lip or spout so that the contents therein can be poured out to another container for consumption by the consumer. The pitcher must also have some type of handle or gripping mechanism to enable physical removal of the pitcher from the blender assembly by the user.

In this conventional system, since a pitcher is a removable container (the pitcher must be removed from the blender assembly to facilitate the dispensing of the blended mixture), the accuracy of the tare weight of the pitcher is essentially always in question because the conventional blender assembly does not ability to identify a specific pitcher to know if the blender assembly has been calibrated for that pitcher.

This conventional system relies on the user's ability keep the correct pitcher matched with the corresponding blender assembly. However, if the blending system is being used in a high production environment, such as a fast food establishment, multiple users may be using the blender systems and there may be multiple blender assemblies with multiple pitchers.

Such an environment defeats the dependency between the pitcher and blender assembly for a proper use of the tare weight of the pitcher to provide an effective metering system because each time a pitcher is placed on the blender assembly that is different from the previously used pitcher, the blending system would have to recalibrate the tare weight of the pitcher. Thus, every time a different pitcher is placed on the blender assembly, a new tare weight needs to be determined.

Alternatively, if there is only one blending system, to maximize the efficiency of the single blending system in a high production environment, multiple pitchers may be used so that a second pitcher can be engaged with the blending assembly while the first pitcher is being cleaned and prepared for the next mixture. In this high production environment, utilizing the conventional metering system of weighing the pitcher and the contents therein in conjunction with multiple pitchers and a single blender assembly, the recalibration process being carried out by the conventional system each time a pitcher is placed on the blender assembly that is different from the previously used pitcher would negatively impact the productivity of the blending system.

An example of this pitcher, blending assembly, and weighing system is disclosed in U.S. Pat. No. 6,194,013. The entire content of U.S. Pat. No. 6,194,013 is hereby incorporated by reference.

Another example of this pitcher, blending assembly, and weighing system is disclosed in U.S. Pat. No. 6,342,260. The entire content of U.S. Pat. No. 6,342,260 is hereby incorporated by reference.

Therefore, it is desirable to provide a blending system that avoids the multiple recalibration process that is required due to the nature of the pitcher being removable for dispensing purposes thus defeating the dependency between the pitcher and the blending assembly for proper tare weight purposes.

Moreover, it is desirable to provide a blending system that eliminates the need for the mobility aspect of the pitcher with respect to the dispensing function of the pitcher so that the need for executing the recalibration process in a metering process (recalibration of the tare weight of the pitcher) is minimized

Furthermore, it is desirable to provide a blending system that eliminates the need to use multiple pitchers to increase productivity and thereby minimizing the need for executing the recalibration process in a metering process (recalibration of the tare weight of the pitcher).

Another conventional solution attempts to prevent the high-speed blade from creating a vortex, cavitation. Cavitation is created by a high speed blade.

Conventionally, the blade is slowed down or shut ON and OFF to prevent or decrease cavitation. However, this process also lengthens the time to blend a drink. To avoid the longer process time, an anti-vortex tool can placed inside the blender. However, the drink still needs to be properly and quickly evacuated without waste. The anti-vortex tool does not address the cleaning issue.

An example of the anti-vortex tool solution is disclosed in U.S. Pat. No. 5,302,021. The entire content of U.S. Pat. No. 5,302,021 is hereby incorporated by reference.

Therefore, it is desirable to provide a blender system that decreases the time needed to produce a drink, reduces waste, and/or provides an efficient cleaning solution.

In addition as noted above, it is desirable to provide a blending system that avoids the multiple recalibration process that is required due to the nature of the pitcher being removable for dispensing purposes thus defeating the dependency between the pitcher and the blending assembly for proper tare weight purposes.

Moreover, it is desirable to provide a blending system that eliminates the need for a mobile pitcher with respect to the dispensing function of the pitcher so that the need for executing the recalibration process in a metering process (recalibration of the tare weight of the pitcher) is minimized

Furthermore, it is desirable to provide a blending system that eliminates the need to use multiple pitchers to increase productivity and thereby minimizing the need for executing the recalibration process in a metering process (recalibration of the tare weight of the pitcher).

### BRIEF DESCRIPTION OF THE DRAWING

The drawings are only for purposes of illustrating various embodiments and are not to be construed as limiting, wherein:

FIG. 1 is a front view of a blending system;

FIG. 2 is a side view of the blending system of FIG. 1;

FIG. 3 illustrates the blending system inputting ice into the blending mechanism;

FIG. 4 illustrates the blending system inputting other ingredients into the blending mechanism;

FIG. 5 illustrates the blending system blending the ice and other ingredients in the blending mechanism;

FIG. 6 illustrates the blending system dispensing the blended ice and other ingredients from the blending mechanism;

FIG. 7 illustrates the blending system utilizing a clean in place process for cleaning the blending mechanism;

FIG. 8 illustrates another example of a blending system utilizing a clean in place process for cleaning the blending mechanism;

FIG. 9 is a front view of another blending system;

FIG. 10 is a flowchart of the blending and clean in place process;

FIG. 11 illustrates another blending system utilizing a clean in place process for cleaning the blending mechanism;

FIG. 12 illustrates another blending system utilizing a clean in place process for cleaning the blending mechanism;

FIG. 13 illustrates another blending system;

FIG. 14 illustrates a weighing sensing unit for the blending system;

FIG. 15 illustrates a front view of another blending chamber for a blending system; and

FIG. 16 shows a side view of the blending chamber of FIG. 15.

### DISCLOSURE OF THE INVENTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

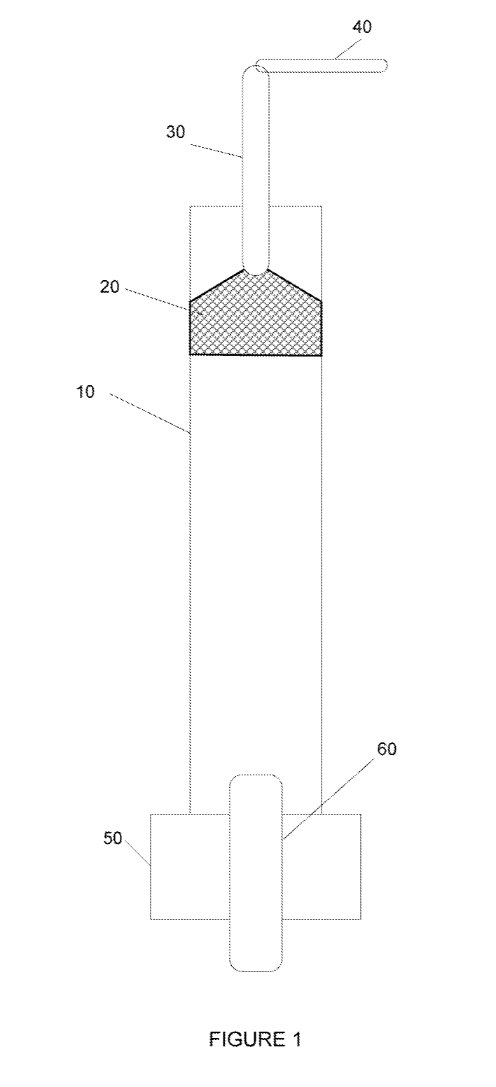

As illustrated in FIG. 1, a blending system includes a blending chamber 10 that receives the ingredients to be blended. The blending system also includes a blending mechanism 50 that includes blades for blending and a motor to drive the blades.

The blending chamber 10 has, therein, a piston/plunger 20 that can move from one end of the blending chamber 10 to the other end. The piston or plunger 20 is driven by a shaft 30. The shaft 30 may be hollow to allow the introduction of ingredients or a cleaning fluid, such as water into the blending chamber 10. In the illustration of FIG. 1, the shaft 30 is hollow to enable the introduction of a cleaning fluid, such as water into the blending chamber 10. The cleaning fluid is introduced through fluid channel 40.

The blended ingredients are dispensed from the blending chamber 10 through dispenser 60.

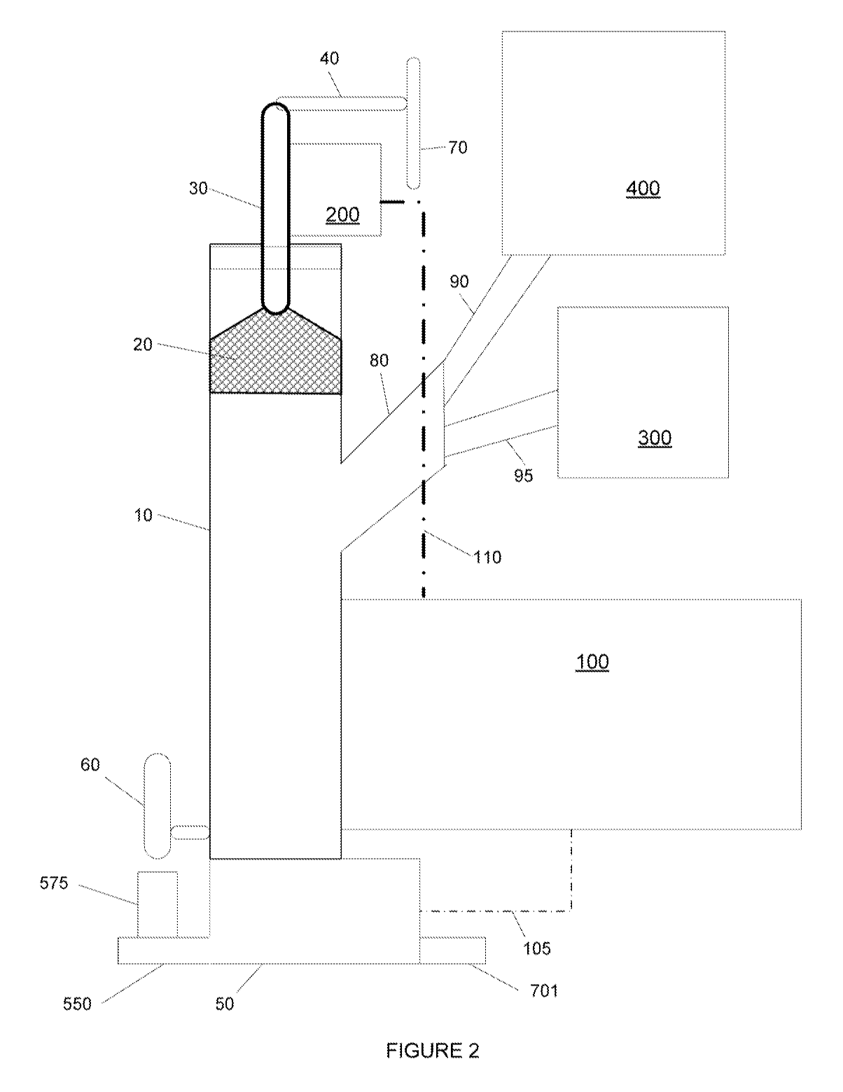

As illustrated in FIG. 2, a blending system includes a blending chamber 10 that receives the ingredients to be blended. The blending system also includes a blending mechanism 50 that includes blades for blending and a motor to drive the blades.

The blending chamber 10 has, therein, a piston/plunger 20 that can move from one end of the blending chamber 10 to the other end. The piston/plunger 20 is driven by a shaft 30. The shaft 30 may be hollow to allow the introduction of ingredients or a cleaning fluid, such as water into the blending chamber 10. In the illustration of FIG. 2, the shaft 30 is hollow to enable the introduction of a cleaning fluid, such as water into the blending chamber 10. The cleaning fluid is introduced through fluid channel 40 and channel 70.

The shaft 30 and the piston/plunger 20 are driven by motor 200. Motor 200 is controlled by control/power unit 100 through electrical connection 110.

Control/power unit 100 also controls the speed and/or state of operation (ON/OFF) of the blending mechanism 50 through electrical connection 105. An exit drain 701 is included to dispose of any waste as well as any cleaning liquids.

It is noted that the blending mechanism 50 may include a weight sensor or weight sensing unit to measure the weight of the ingredients being introduced into the blending chamber 10. This weight sensor or weight sensing unit can provide the appropriate measurement data to the control/power unit 100 so that the ingredients can be properly metered.

In this example, the weight sensing unit may calibrate the tare weight of only the bottom floor of the blending chamber 10 because the floor would float upon the weight sensing unit and the remaining portion of the blending chamber 10 would be fixed to the blending system.

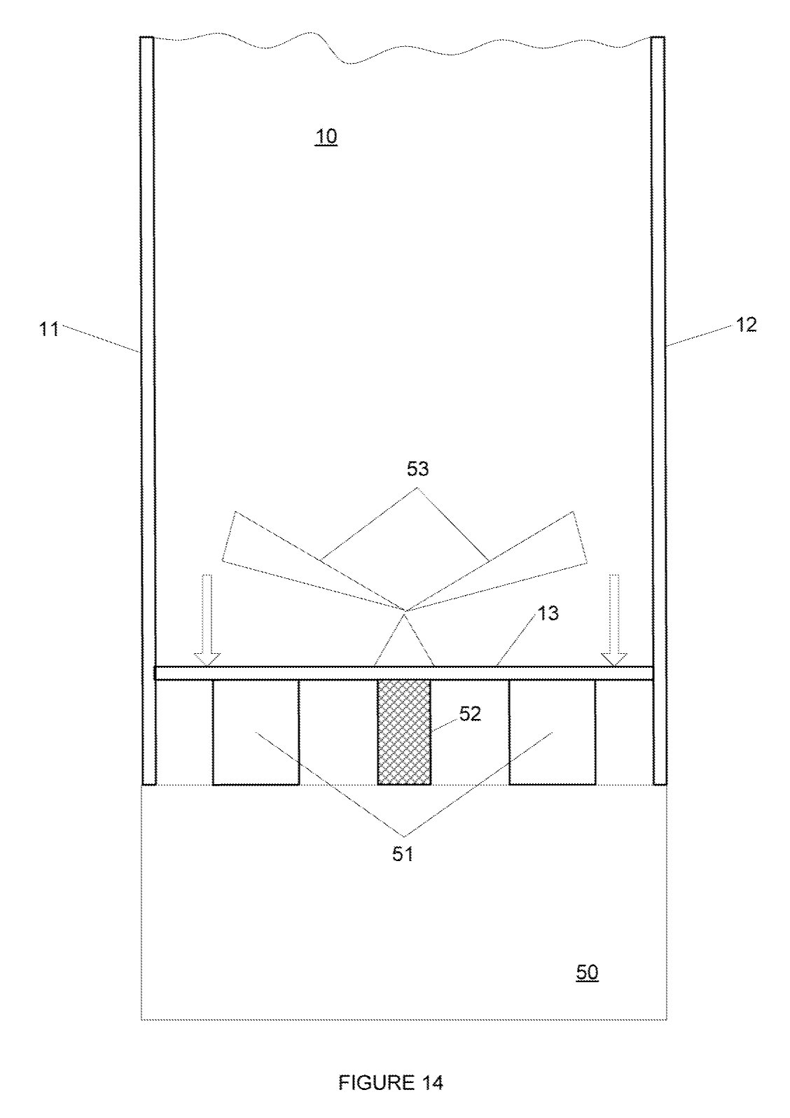

FIG. 14 illustrates an example of the weight sensing unit. As illustrated in FIG. 14, the blending mechanism 50 includes weight sensors 51 which measures the weight of the bottom floor 13 of the blending chamber 10, the blending assembly (including blending or mixing blades 53), and the weight of the ingredients (represented by the arrows) within the blending chamber 10.

In this example, to determine a tare weight or calibration weight, the weight sensing unit only needs to measure the weight of the bottom floor 13 of the blending chamber 10 and the blending assembly (including blending or mixing blades 53) because the sides (11 and 12) of the blending chamber 10 are not positioned upon the weighing platform, namely the bottom floor 13 of the blending chamber 10.

Since the bottom floor 13 of the blending chamber 10 and the blending assembly (including blending or mixing blades 53) are not removed to dispense the mixture from the blending chamber 10, the tare weight or calibration weight does not need to be determined in a frequent manner or after each dispensing as in a system that utilizes pitchers to dispense the mixture.

It is noted that the bottom floor 13 of the blending chamber 10 and the blending assembly (including blending or mixing blades 53) can be removed for detail cleaning at breakdown of the blending system; however, since the blending system has only a single bottom floor 13 of the blending chamber 10 with blending assembly (including blending or mixing blades 53), the tare weight or calibration weight does not need to be determined after a breakdown cleaning.

It is further noted that the FIG. 14 illustrates a rotating drive mechanism 52 that provides the rotation of the blending assembly (including blending or mixing blades 53). The rotating drive mechanism 52 engages the blending assembly (including blending or mixing blades 53) and the bottom floor 13 of the blending chamber 10 so as not to impact the weight measurement.

It is further noted that the weight sensors may be located at other locations beneath the bottom floor 13 of the blending chamber 10 and the blending assembly (including blending or mixing blades 53).

Alternatively, it is noted that the sides (11 and 12) of the blending chamber 10 may be positioned upon the weighing platform, namely the bottom floor 13 of the blending chamber 10, and thus, the sides (11 and 12) of the blending chamber 10 may be incorporated in the tare weight or calibration weight determination. However, the tare weight or calibration weight does not need to be determined in a frequent manner or after each dispensing as in a system that utilizes pitchers to dispense the mixture because the sides (11 and 12) of the blending chamber 10 or the blending chamber 10 are not removed to dispense the mixture from the blending chamber 10.

It is noted that the sides (11 and 12) of the blending chamber 10 can be removed for detail cleaning at breakdown of the blending system; however, since the blending system has only the sides (11 and 12) of the blending chamber 10, the tare weight or calibration weight does not need to be determined after a breakdown cleaning.

In the example illustrated in FIG. 2, the blending system includes an ice bin 400 for storing ice. Moreover, the blending system includes an ingredient bin 300 for storing the blending ingredient(s). The ice and ingredient(s) are transported to the receiving opening 80 of the blending chamber 10, through conduit 90 and conduit 95, respectively.

It is noted that the ingredient bin 300 may be compartmentalized to store multiple ingredients. In addition, it is noted that the bin 400 may store ice cream, soft serve ice cream, or other frozen products that are utilized in making a frozen drink or frozen food item.

The blended ingredients are dispensed from the blending chamber 10 through dispenser 60 into a consumer container 575 which rests upon consumer container holding platform 550. It is noted that consumer container holding platform 550 may contain a drain (not shown) to capture any waste or overflow from the dispensing process.

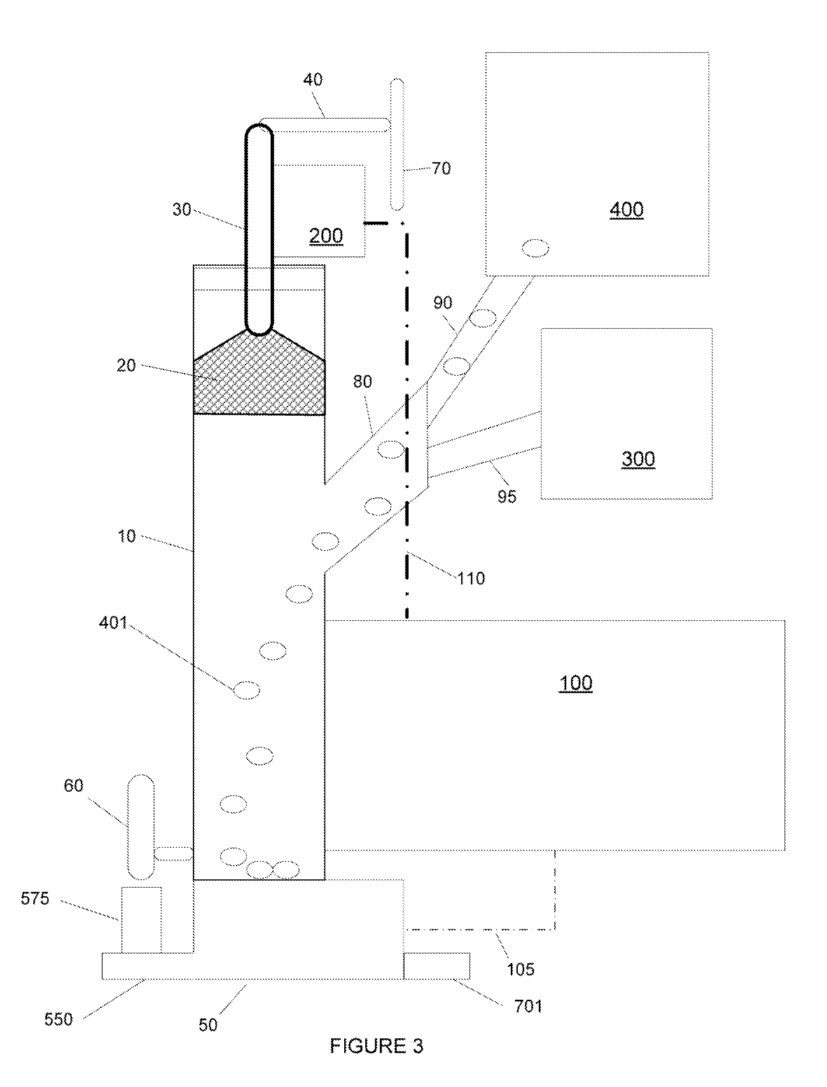

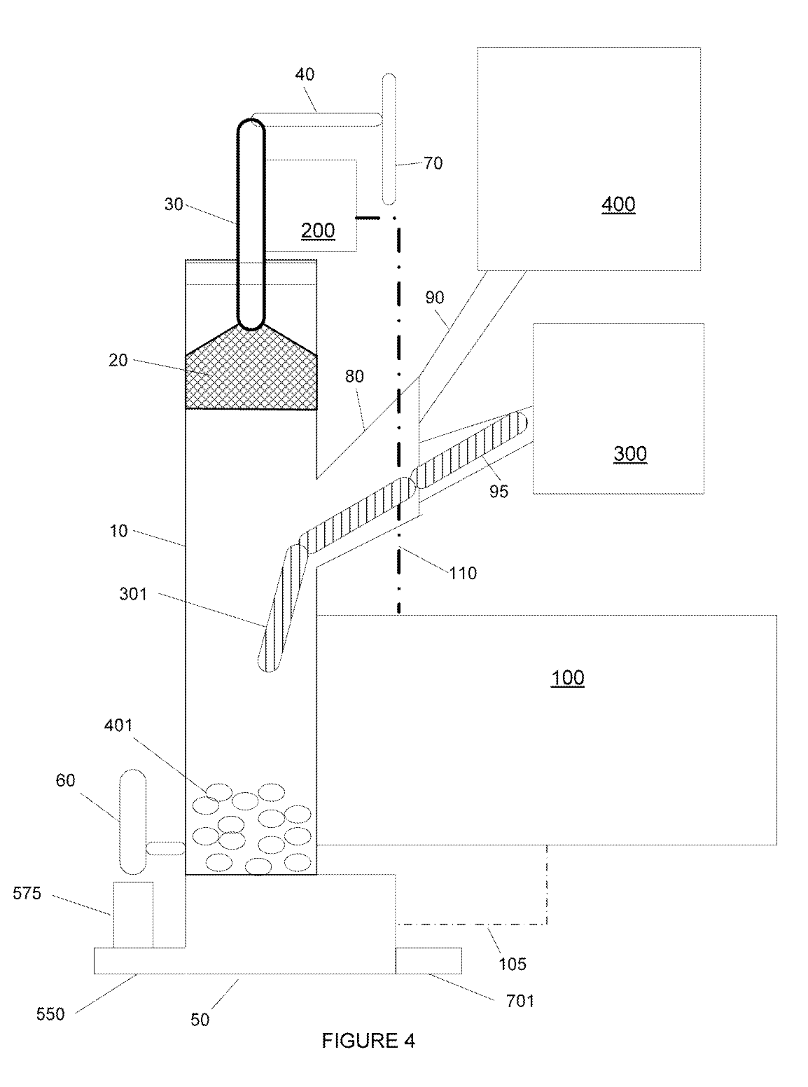

As illustrated in FIG. 3, the blending chamber 10 of the blending system receives ice 401 from ice bin 400. In FIG. 4, the blending chamber 10 of the blending system receives blending ingredient(s) 301 from ingredient bin 300. The blending system also includes a blending mechanism 50 that includes blades for blending and a motor to drive the blades.

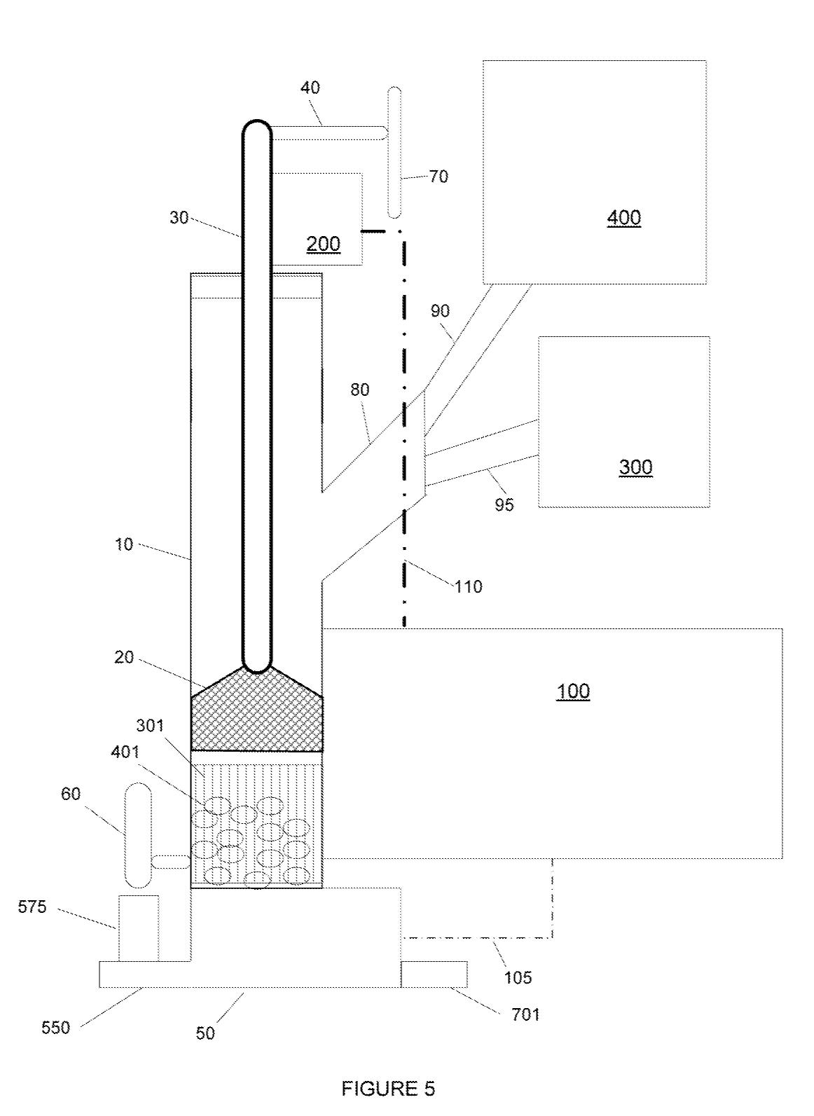

As illustrated in FIG. 5, the piston/plunger 20 engages the ice 401 and the blending ingredients 301. During this engagement of the piston/plunger 20, the control/power unit 100 starts the blending process by turning ON the blending mechanism 50. The piston/plunger 20 keeps the ice 401 and the blending ingredients 301 in close engagement with the blades of the blending mechanism 50 so as to reduce the blending time and to prevent or decrease cavitation.

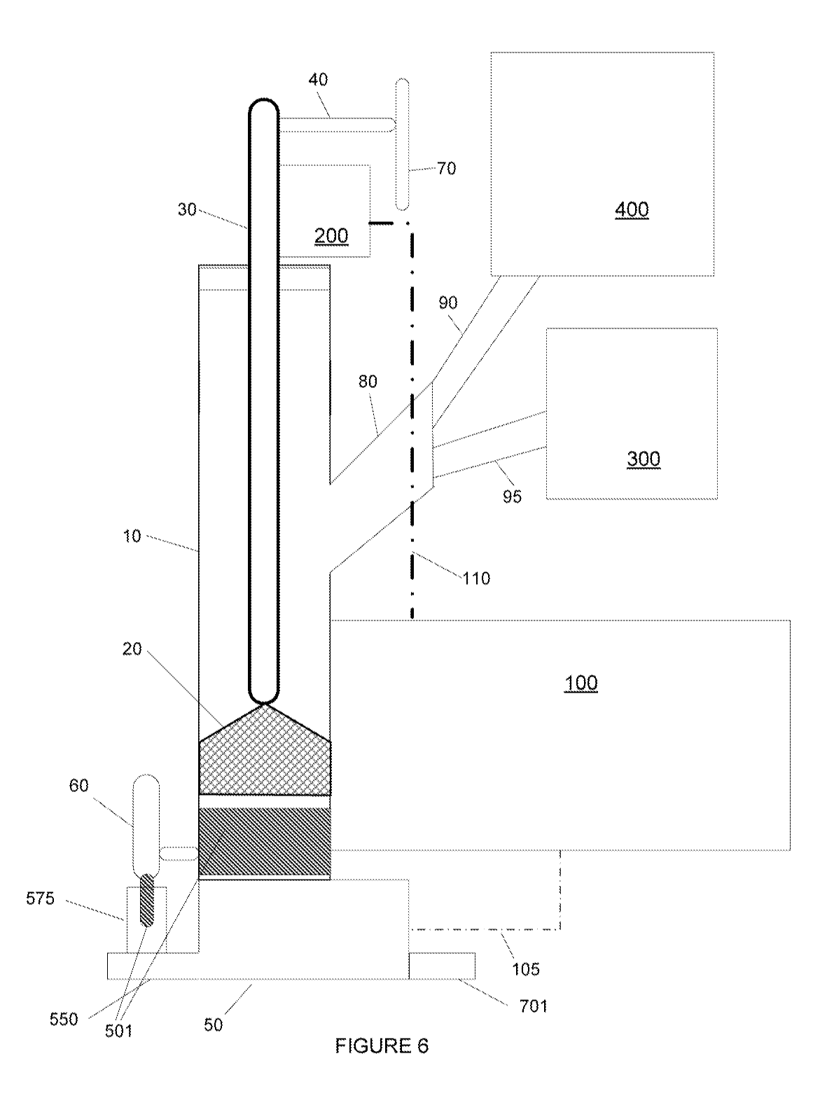

As illustrated in FIG. 6, the piston/plunger 20 travels further towards the blending mechanism 50 engaging the blended ice 401 and blending ingredients 301. During this cycle, the dispenser 60 opens to allow the evacuation of the blended mixture 501 into a consumer container 575 which rests upon consumer container holding platform 550. The opening and closing of the dispenser 60 may be controlled by control/power unit 100 or may be manually controlled.

It is noted that the blending mechanism 50 may continue to rotate the blades during dispensing to assist in the evacuation of the blended mixture 501.

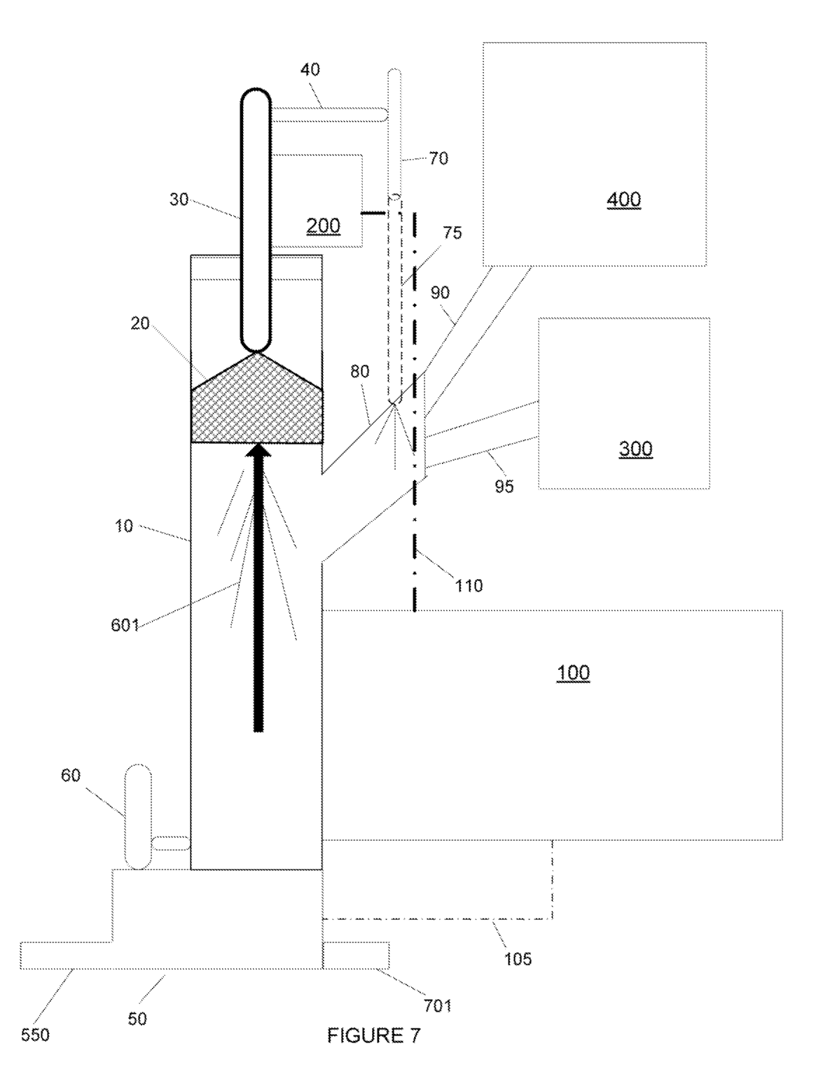

After evacuation, as illustrated in FIG. 7, a clean in place process starts wherein the piston/plunger 20 travels away from the blending mechanism 50 and a cleaning fluid 601, such as water, enters the blending chamber 10. The blending mechanism 50 is turned ON to cause an agitation of the cleaning fluid 601 so as to clean the blending chamber 10 and the blades of the blending mechanism 50. It is noted that the cleaning fluid 601 may also be introduced into the receiving opening 80 to clean this chamber.

Upon finishing the cleaning in place cycle, the cleaning fluid is discharged from the blending chamber 10 and out of the blending system by exit drain or discharge conduit 701. It is noted that the piston/plunger 20 may also travel towards the blending mechanism 50 during the agitation of the cleaning fluid 601 so as to clean the piston/plunger 20, as well as, to assist in evacuating the cleaning fluid 601 from the blending chamber 10.

As illustrated in FIG. 7, the consumer container holding platform 550 shifts outwardly so that a back portion of the consumer container holding platform 550 is positioned under the dispenser 60. The cleaning fluid is discharged through the dispenser 60 and into an opening (not shown) in the back portion which enables the discharged cleaning fluid to be directed to the exit drain or discharge conduit 701.

The consumer container holding platform 550 may be positively biased to the position illustrated in FIG. 7 so that when the consumer container 575 is removed, the consumer container holding platform 550 automatically shifts outwardly.

It is noted that the consumer container holding platform 550 may be normally in the position illustrated in FIG. 6 so that when the consumer container 575 is removed, a sensor may sense the absence of the consumer container 575, which causes the consumer container holding platform 550 to be driven outwardly.

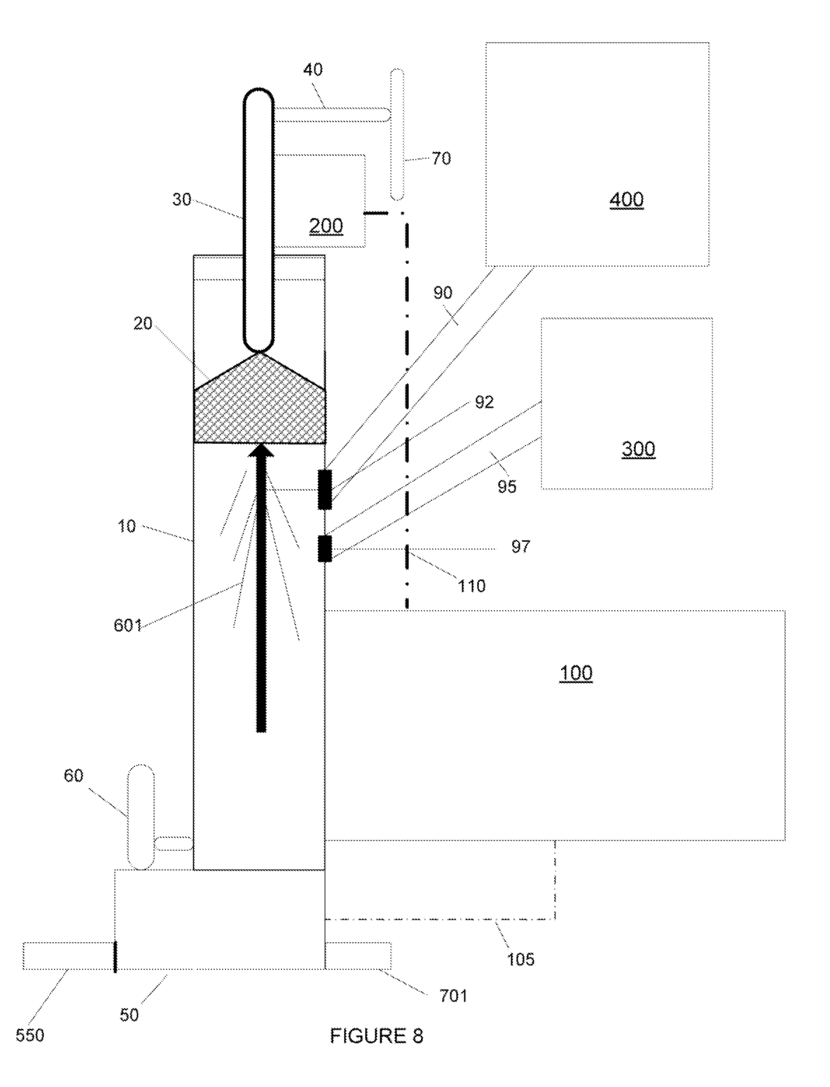

In another embodiment, as illustrated in FIG. 8, the receiving opening 80 is replaced with direct connection of the ice bin 400 and the blending ingredient(s) bin 300 to the blending chamber 10. This direct connection may be facilitated by valves 92 and 97. These valves may be one way valves. These valves may also be controlled by the control/power unit 100 so that the ice and/or ingredients can be metered into the blending chamber 10.

It is noted that the blending chamber 10 may be removable to facilitate a more through cleaning on a daily basis, for example.

As illustrated in FIG. 8, the consumer container holding platform 550 shifts outwardly so that a back portion of the consumer container holding platform 550 is positioned under the dispenser 60. The cleaning fluid is discharged through the dispenser 60 and into an opening (not shown) in the back portion which enables the discharged cleaning fluid to be directed to the exit drain or discharge conduit 701.

The consumer container holding platform 550 may be positively biased to the position illustrated in FIG. 8 so that when the consumer container 575 is removed, the consumer container holding platform 550 automatically shifts outwardly.

It is noted that the consumer container holding platform 550 may be normally in the position illustrated in FIG. 6 so that when the consumer container 575 is removed, a sensor may sense the absence of the consumer container 575, which causes the consumer container holding platform 550 to be driven outwardly.

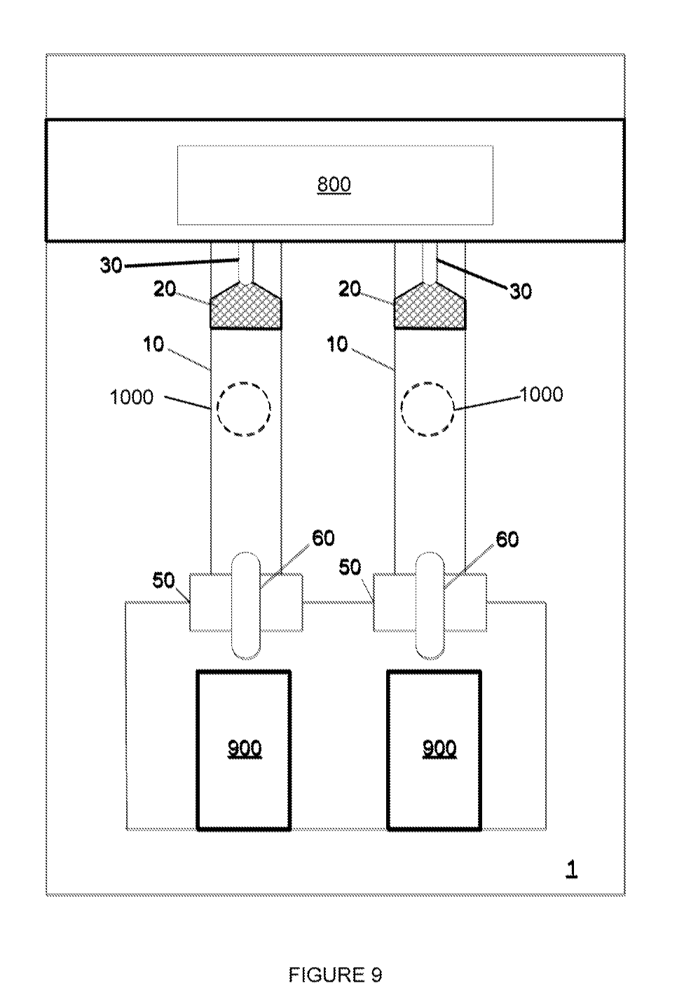

FIG. 9 shows a front view of a blending system 1 which includes two blending chambers 10 that receives the ingredients to be blended through receiving openings 1000. The receiving openings 1000 can be located in the back to receive items blending ingredients stored within the blending system 1. In addition, the receiving openings 1000 can be located in the front of the blending system 1 to receive blending ingredients introduced directly by the user or operator.

The blending system also includes a blending mechanism 50 that includes blades for blending and a motor to drive the blades.

Each blending chamber 10 has, therein, a piston/plunger 20 that can move from one end of the blending chamber 10 to the other end. Each piston/plunger 20 is driven by a shaft 30. The shaft 30 may be hollow to allow the introduction of ingredients or a cleaning fluid, such as water into the blending chamber 10.

In the illustration of FIG. 8, a user interface panel 800 is included to allow the user to program the blending system 1 to create different blended mixtures.

The shaft 30 and the piston/plunger 20 are driven by motor 200. Motor 200 is controlled by control/power unit 100 through electrical connection 110.

The blended ingredients are dispensed from the blending chamber 10 through dispenser 60.

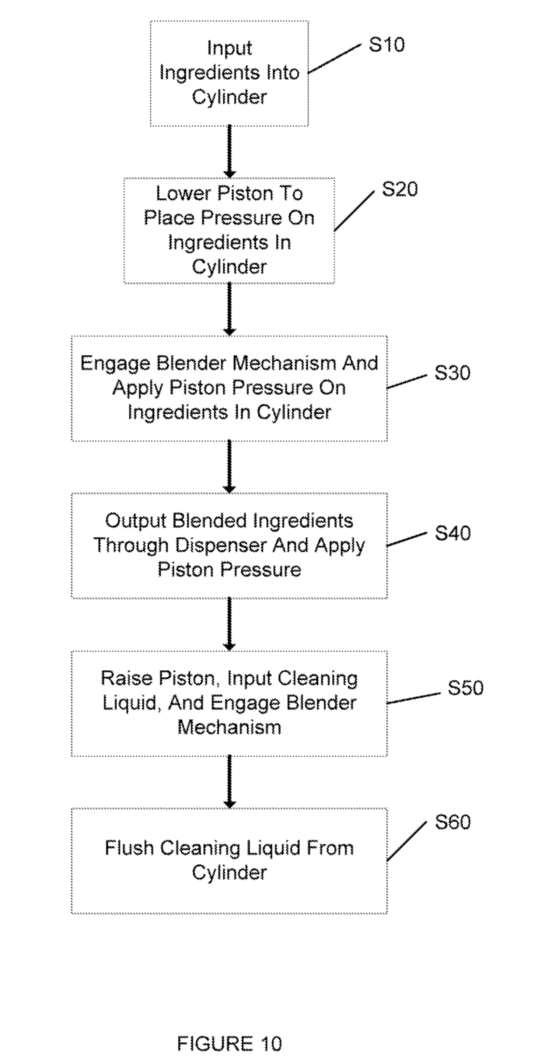

FIG. 10 illustrates a flowchart of the blending and clean in place process utilized by the blending systems described above.

As illustrated in FIG. 10, at step S10, the blending ingredients are introduced into the blending chamber. At step S20, the piston/plunger is lowered into position to place some pressure upon the blending ingredients in the blending chamber.

At step S30, the piston/plunger engages the blending ingredients in conjunction with the starting of the blending process performed by the blades of a blending mechanism. The piston/plunger engages the blending ingredients, during the blending process, so as to reduce the blending time and to prevent or decrease cavitation.

At step S40, the piston/plunger further engages the blended ingredients, and a dispenser is opened to allow the evacuation of the blended mixture into a container.

As noted above, the blending process is maintained while further lowering the piston/plunger to assist in dispensing the blended ingredients. The piston/plunger may be lowered until the piston/plunger reaches the bottom of the blending chamber. Thereafter, when the shaft is hollow and an air valve is utilized with the piston/plunger, the air valve is opened and the piston/plunger is raised a short distance. The air valve is then closed and the piston/plunger is lowered, which causes a positive air pressure between the piston/plunger and the top surface of the remaining blended ingredients. The positive air pressure causes the last of the blended ingredients to be evacuated into a container, thereby significantly reducing or substantially eliminating waste.

At step S50, a clean in place process starts wherein the piston/plunger travels away from the blending mechanism and a cleaning fluid, such as water, enters the blending chamber. The blending mechanism is turned ON to cause an agitation of the cleaning fluid so as to clean the blending chamber and the blades of the blending mechanism.

At step S60, upon finishing the cleaning in place cycle, the cleaning fluid is discharged from the blending chamber and out of the blending system by a discharge conduit. It is noted that the piston/plunger may also travel towards the blending mechanism during the agitation of the cleaning fluid so as to clean the piston/plunger, as well as, to assist in evacuating the cleaning fluid from the blending chamber.

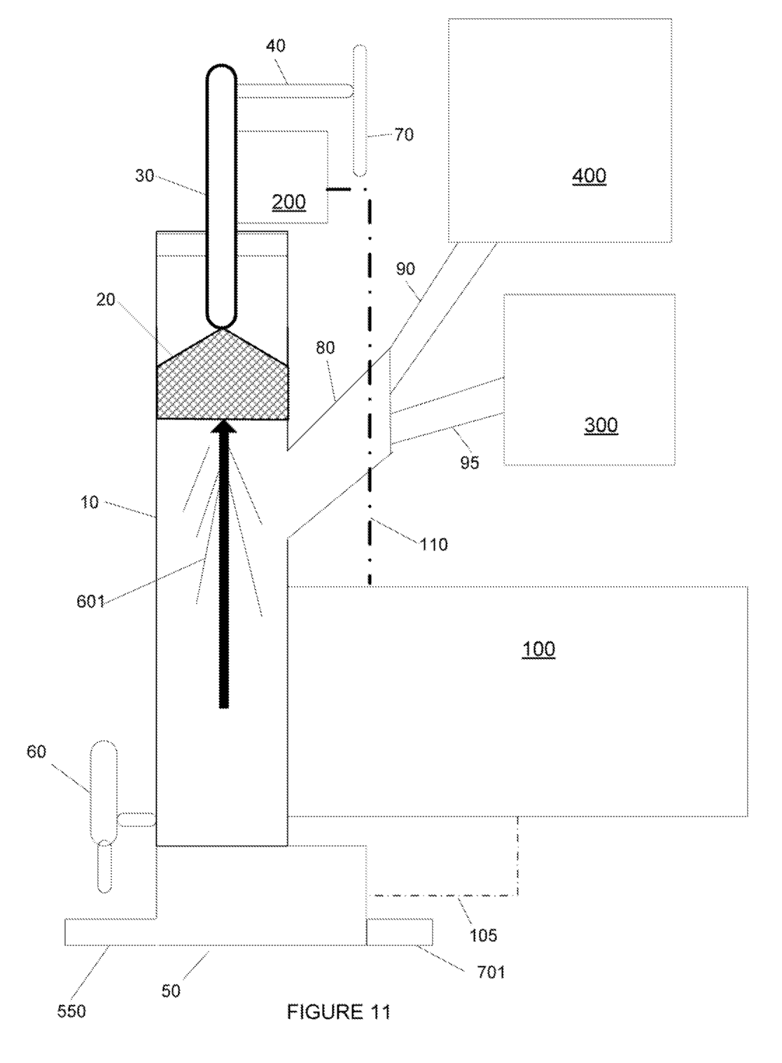

Alternatively, after evacuation, as illustrated in FIG. 11, a clean in place process starts wherein the piston/plunger 20 travels away from the blending mechanism 50 and a cleaning fluid 601, such as water, enters the blending chamber 10. The blending mechanism 50 is turned ON to cause an agitation of the cleaning fluid 601 so as to clean the blending chamber 10 and the blades of the blending mechanism 50. It is noted that the cleaning fluid 601 may also be introduced into the receiving opening 80 to clean this chamber.

Upon finishing the cleaning in place cycle, the cleaning fluid is discharged from the blending chamber 10 and out of the blending system by exit drain or discharge conduit 701. It is noted that the piston/plunger 20 may also travel towards the blending mechanism 50 during the agitation of the cleaning fluid 601 so as to clean the piston/plunger 20, as well as, to assist in evacuating the cleaning fluid 601 from the blending chamber 10.

As illustrated in FIG. 11, the consumer container holding platform 550 does not shift. The cleaning fluid is discharged through the dispenser 60 and into an opening (not shown) in consumer container holding platform 550 which enables the discharged cleaning fluid to be directed to the exit drain or discharge conduit 701.

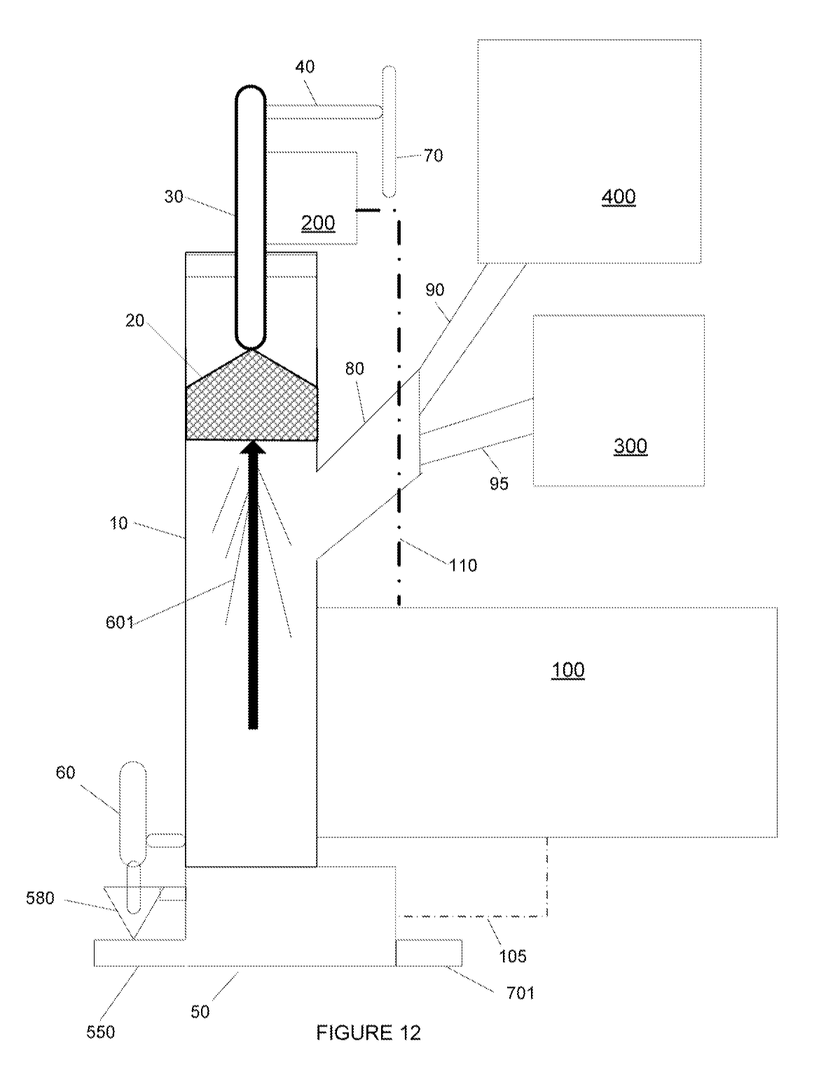

In another alternative, after evacuation, as illustrated in FIG. 12, a clean in place process starts wherein the piston/plunger 20 travels away from the blending mechanism 50 and a cleaning fluid 601, such as water, enters the blending chamber 10. The blending mechanism 50 is turned ON to cause an agitation of the cleaning fluid 601 so as to clean the blending chamber 10 and the blades of the blending mechanism 50. It is noted that the cleaning fluid 601 may also be introduced into the receiving opening 80 to clean this chamber.

Upon finishing the cleaning in place cycle, the cleaning fluid is discharged from the blending chamber 10 and out of the blending system by exit drain or discharge conduit 701. It is noted that the piston/plunger 20 may also travel towards the blending mechanism 50 during the agitation of the cleaning fluid 601 so as to clean the piston/plunger 20, as well as, to assist in evacuating the cleaning fluid 601 from the blending chamber 10.

As illustrated in FIG. 12, the consumer container holding platform 550 does not shift. However, a funnel or discharge capture unit 580 is positioned under the dispenser 60. The cleaning fluid is discharged through the dispenser 60 and into the funnel or discharge capture unit 580 which enables the discharged cleaning fluid to be directed to the exit drain or discharge conduit 701.

The funnel or discharge capture unit 580 may be positively biased to the position illustrated in FIG. 12 so that when the consumer container 575 is removed, the funnel or discharge capture unit 580 automatically shifts outwardly.

It is noted that the funnel or discharge capture unit 580 may be normally in the back portion of consumer container holding platform 550 so that when the consumer container 575 is removed, a sensor may sense the absence of the consumer container 575, which causes the funnel or discharge capture unit 580 to be driven outwardly.

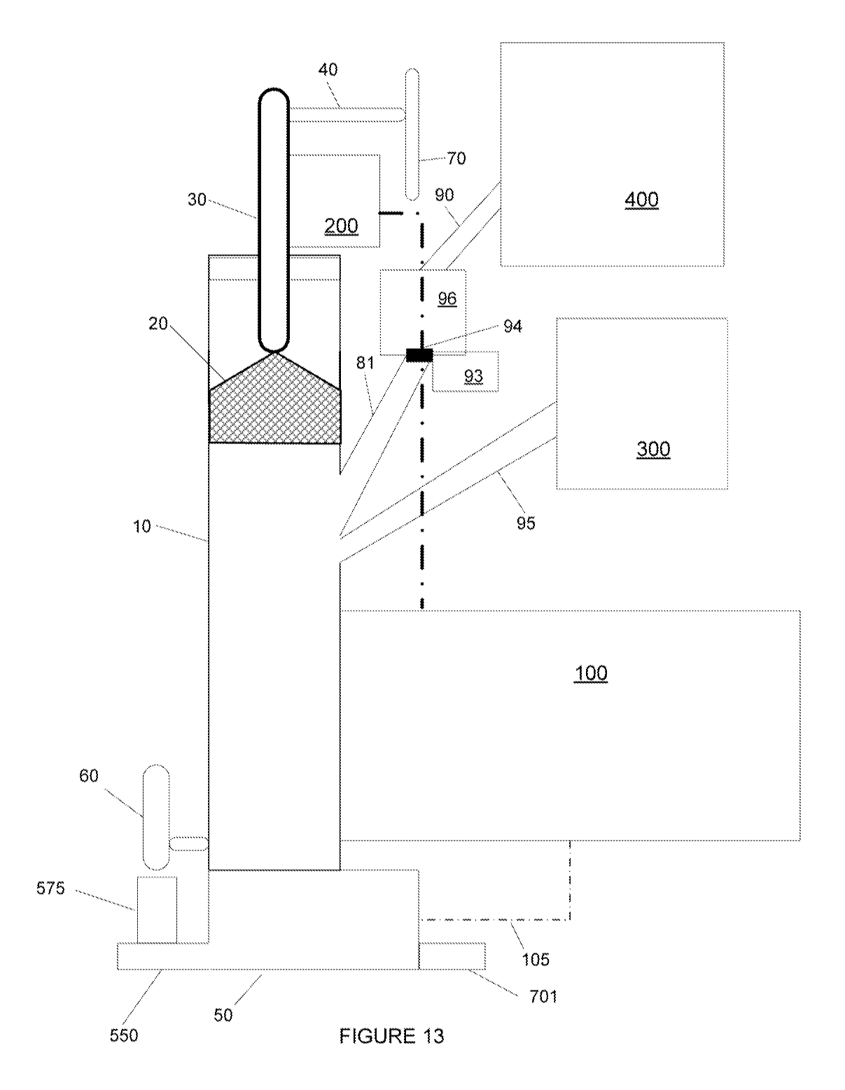

As illustrated in FIG. 13, a blending system includes a blending chamber 10 that receives the ingredients to be blended. The blending system also includes a blending mechanism 50 that includes blades for blending and a motor to drive the blades.

The blending chamber 10 has, therein, a piston/plunger 20 that can move from one end of the blending chamber 10 to the other end. The piston/plunger 20 is driven by a shaft 30. The shaft 30 may be hollow to allow the introduction of ingredients or a cleaning fluid, such as water into the blending chamber 10. In the illustration of FIG. 13, the shaft 30 is hollow to enable the introduction of a cleaning fluid, such as water into the blending chamber 10. The cleaning fluid is introduced through fluid channel 40 and channel 70.

The shaft 30 and the piston/plunger 20 are driven by motor 200. Motor 200 is controlled by control/power unit 100 through electrical connection 110.

Control/power unit 100 also controls the speed and/or state of operation (ON/OFF) of the blending mechanism 50 through electrical connection 105. An exit drain 701 is included to dispose of any waste as well as any cleaning liquids.

In the example illustrated in FIG. 13, the blending system includes an ice bin 400 for storing ice. Moreover, the blending system includes an ingredient bin 300 for storing the blending ingredient(s). The ingredient(s) are transported to the blending chamber 10 through conduit.

With respect to the ice, the ice is initially transferred to an ice weighing bin 96 where the ice's weight is measured by weighing unit 93. Upon receiving the appropriate weight of ice in the ice weighing bin 96, the ice bin 400 terminates any transferring of ice to the ice weighing bin 96, and a gate 94 is opened to transfer the ice to conduit 81 which enables the ice to be introduced into the blending chamber 10. In this example, the ice is weighed/measured in a non-blending chamber or container.

It is noted that the weighing unit 93 can provide the appropriate measurement data to the control/power unit 100 so that the ice can be properly metered.

It is noted that the ingredient bin 300 may be compartmentalized to store multiple ingredients. In addition, it is noted that the bin 400 may store ice cream, soft serve ice cream, or other frozen products that are utilized in making a frozen drink or frozen food item.

The blended ingredients are dispensed from the blending chamber 10 through dispenser 60 into a consumer container 575 which rests upon consumer container holding platform 550. It is noted that consumer container holding platform 550 may contain a drain (not shown) to capture any waste or overflow from the dispensing process.

As noted above, a cylindrical vessel blends ingredients with a rotating blade in a blending vessel or container and uses a piston/plunger to exert pressure upon the ingredients. This pressure prevents cavitation in the blade area and simultaneously prevents the upper levels of ingredients from rotating or swirling in unison with the rotating blades.

At the end of this initial blend cycle, an exit valve, below the blades, opens and the piston pushes the partially blended ingredients, at a controlled rate, past the rotating blade(s) creating consistent and uniform blend of ingredients that exit the valve and into a serving container. After dispensing to a serving container, the vessel and piston are self-clean by the clean in place process.

As noted above, the blending chamber or vessel has an exit valve located just below the blades so that the exit valve dispenses the blended drink into a serving cup as opposed to the conventional removing of the vessel and pouring the contents out.

Moreover, the blending chamber or vessel is cleaned in place without being removed from the blending mechanism.

Although the above systems have been described with respect to a based frozen mixture (drink), the blending system can be utilized to dispense both soft serve ice cream and icy drinks, like a Slushy™, without the constant freezing and unfreezing of the beverage in the constantly rotating drum.

In the examples discussed above with respect to the blending ingredients being stored within the blending system, the dispensing of these ingredients can be automated so that the dispensing is accurate.

It is noted that the piston/plunger may have a tight fit along the sidewalls of the blending chamber, but not airtight so that air is allowed to escape between the side of the piston/plunger and the walls of the blending chamber.

It is further noted that the piston/plunger may have an air tight seal with the sidewalls of the blending chamber. In this embodiment, the shaft of the piston/plunger may be hollow and may have an air valve connected at its end. The air valve is opened during the decent of the piston/plunger from the top of the blending chamber to the top surface of the blending ingredient mixture to prevent an “air lock.”

The air valve enables control of the speed of egress of the ingredient mixture. By slowing the speed of the piston/plunger, a finer ice particle can be generated by just moving the piston/plunger slowly while the dispenser is opened and the air valve is closed. This situation creates a vacuum to slow the speed of the dispensing.

Once the piston hits the top of the mixture, which can be sensed in number of conventional ways, the air valve is closed. If the air valve was not closed at this point, a small amount of ice or ingredient could traverse up the air tube that extends from the bottom of the piston to the top of the piston shaft.

The piston/plunger puts pressure on the mixture during the blending to prevent a vortex with an air pocket from forming on the bottom, in other words, a cavitation caused by the rotating blades. The piston/plunger may also prevent the ice and ingredient mixture from rotating or swirling at the top levels of the mixture.

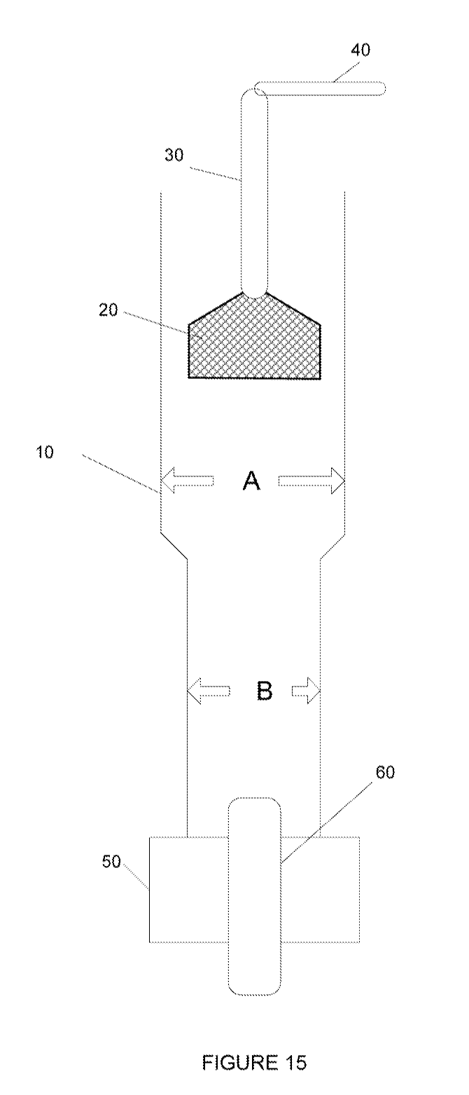

FIG. 15 illustrates another configuration of the blending chamber 10. As illustrated in FIG. 15, the blending chamber 10 has an upper portion and a lower portion wherein the lower portion has a horizontal dimension B which is less than a horizontal dimension A of the upper portion. In other words, the blending chamber 10 is tapered outwardly to create a wider upper portion. The wider upper portion allows the piston/plunger 20 to physically disengage from the blending chamber so as not to interfere/impact with the weighing process.

The tapering of the blending chamber 10 may be forty-five degrees. In addition, the horizontal dimension B of the lower portion may be approximately 6.25 cm and the horizontal dimension A of the upper portion may be approximately 8.75 cm.

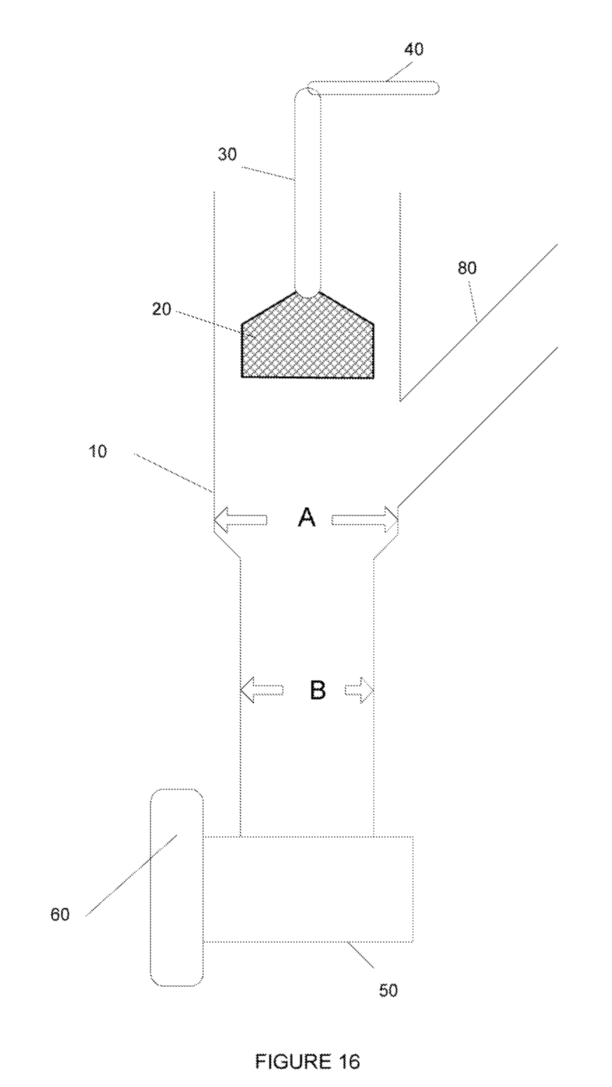

FIG. 16 illustrates a side view of the configuration of the blending chamber 10, as illustrated in FIG. 15.

### BEST MODE FOR CARRYING OUT THE INVENTION

In summary, a method of blending and dispensing a frozen mixture introduces ingredients into a blending chamber; lowers a piston into position to place pressure upon the ingredients within the blending chamber; engages the ingredients with the piston; blends the ingredients using a rotating blade while the piston is engaging the ingredients; opens a dispensing mechanism, after expiration of a predetermined period of time; maintains the blending process while further lowering the piston to assist in dispensing the blended ingredients; closes the dispensing mechanism and moving the piston away from the rotating blade; introduces a clean fluid into the blending chamber; agitates the cleaning fluid to clean the blending chamber and blade; and discharges the cleaning fluid from the blending chamber.

It is noted that the blade may rotate to agitate the cleaning fluid. Furthermore, the blade may rotate during the dispensing of the blended ingredients from the blending chamber.

It is noted that the piston may be lowered during the agitation of the cleaning fluid or during the discharging of the cleaning fluid.

It is further noted that the blending chamber may be cleaned by the cleaning fluid without being moved, and the ingredients may be metered into the blending chamber. One ingredient may be weighed to enable proper metering of the ingredient into the blending chamber wherein the one ingredient may be weighed outside the blending chamber to enable proper metering of the ingredient into the blending chamber or weighed within the blending chamber to enable proper metering of the ingredient into the blending chamber.

The cleaning fluid may be discharged from the blending chamber through the dispensing mechanism. A drain may be positioned under the dispensing mechanism when the cleaning fluid is discharged from the blending chamber, or the dispensing mechanism may be positioned over a drain when the cleaning fluid is discharged from the blending chamber, or the dispensing mechanism may be positioned over a discharge capture unit when the cleaning fluid is discharged from the blending chamber, or the discharge capture unit may be positioned under the dispensing mechanism when the cleaning fluid is discharged from the blending chamber.

A system for blending and dispensing a frozen mixture includes a blending chamber to receive the ingredients to be blended; a blending mechanism including a rotating blade for blending and a motor to drive the blade; a piston, located within the blending chamber; a dispensing mechanism to dispense a blended mixture from the blending chamber; and a discharge mechanism to discharge a cleaning fluid from the blending chamber.

The piston is moved into a first position with respect to the blending mechanism during a blending cycle. The piston is moved into a second position with respect to the blending mechanism during a dispensing cycle, the second position being closer to the blending mechanism than the first position.

The piston is moved into a third position with respect to the blending mechanism during an introduction of a cleaning fluid into the blending chamber, the third position being farther away from the blending mechanism than the first position. The piston is moved into a fourth position with respect to the blending mechanism during a discharging of the cleaning fluid cycle.

It is noted that the blade may rotate to agitate the cleaning fluid. Furthermore, the blade may rotate during the dispensing of the blended ingredients from the blending chamber.

It is noted that the piston may be moved into a fifth position with respect to the blending mechanism during a cleaning cycle.

A user interface may program a blending and dispensing of selected ingredients. The user interface may enable a programming of a cleaning cycle.

The cleaning cycle may be automatic.

It is noted that the system may include a container to store ice, a container to store a frozen product, or a container to store ingredients to be blended.

A control unit may be used to control the positioning of the piston and the operations of the blending mechanism. A weighing mechanism may be included to weigh one ingredient to enable proper metering of the ingredient into the blending chamber.

In addition an ingredient weighing bin may be included to hold the ingredient being weighed by the weighing mechanism, the ingredient weighing bin causing the weighed ingredient to be transferred to the blending chamber when a predetermined weight is measured so as to enable proper metering of the ingredient into the blending chamber wherein the one ingredient is weighed by the weighing mechanism when the one ingredient is within the blending chamber to enable proper metering of the ingredient into the blending chamber.

The cleaning fluid may be discharged from the blending chamber through the dispensing mechanism. A drain unit may be positioned under the dispensing mechanism when the cleaning fluid is discharged from the blending chamber, or the dispensing mechanism may be positioned over the drain unit when the cleaning fluid is discharged from the blending chamber.

A discharge capture unit may be positioned under the dispensing mechanism and over a drain when the cleaning fluid is discharged from the blending chamber, or the dispensing mechanism may positioned over the discharge capture unit when the cleaning fluid is discharged from the blending chamber.

A method of blending and dispensing a mixture introduces ingredients into a blending chamber; moves a piston into position to engage the ingredients within the blending chamber; blends the ingredients using a rotating blade while the piston engages the ingredients; opens a dispensing mechanism, after expiration of a predetermined period of time; maintains the blending process while further moving the piston closer to the rotating blade to assist in dispensing the blended ingredients; moves the piston away from the rotating blade while introducing air into the blending chamber between the piston and the blended ingredients; moves the piston closer to the rotating blade to dispense a remainder of the blended ingredients; closes the dispensing mechanism and moving the piston away from the rotating blade; introduces a clean fluid into the blending chamber; agitates the cleaning fluid to clean the blending chamber and blade; and discharges the cleaning fluid from the blending chamber.

A system for blending and dispensing a mixture, includes a blending chamber to receive ingredients to be blended; a blending mechanism including a rotating blade for blending and a motor to drive the blade; a piston, located within the blending chamber; a hollow shaft connected to the piston to cause the piston to move with the blending chamber, the hollow shaft having an air valve at an end opposite an end having the piston connected thereto; a dispensing mechanism to dispense a blended mixture from the blending chamber; and a discharge mechanism to discharge a cleaning fluid from the blending chamber.

The piston is moved to a first position with respect to the blending mechanism during a blending cycle. The piston is moved to a second position with respect to the blending mechanism during a dispensing cycle, the second position being closer to the blending mechanism than the first position. The piston is moved to a third position with respect to the blending mechanism during a dispensing cycle, the second position being closer to the blending mechanism than the third position. The air valve is opened when the piston is moved to the third position to enable air to flow through the hollow shaft into the blending chamber.

The piston is moved to a fourth position with respect to the blending mechanism during a dispensing cycle, the fourth position being closer to the blending mechanism than the third position. The piston is moved to a fifth position with respect to the blending mechanism during an introduction of a cleaning fluid into the blending chamber, the fifth position being farther away from the blending mechanism than the fourth position. The piston is moved into a sixth position with respect to the blending mechanism during a discharging of the cleaning fluid cycle.

A method of blending and dispensing a mixture meters a first ingredient into a blending chamber by weighing the first ingredient within the blending chamber; introduces a second ingredient into the blending chamber; moves a piston into position to engage the ingredients within the blending chamber; blends the ingredients using a rotating blade while the piston engages the ingredients; opens a dispensing mechanism, after expiration of a predetermined period of time; maintains the blending process while further moving the piston closer to the rotating blade to assist in dispensing the blended ingredients; closes the dispensing mechanism and moving the piston away from the rotating blade; introduces a clean fluid into the blending chamber; agitates the cleaning fluid to clean the blending chamber and blade; and discharges the cleaning fluid from the blending chamber.

A system for blending and dispensing a mixture includes a blending chamber to receive ingredients to be blended; a blending mechanism including a rotating blade for blending and a motor to drive the blade; a piston, located within the blending chamber; a dispensing mechanism to dispense a blended mixture from the blending chamber; a discharge mechanism to discharge a cleaning fluid from the blending chamber; a weighing mechanism for measuring a weigh of a first ingredient within the blending chamber; and a metering mechanism to meter the first ingredient in response the weight, measured by the weighing mechanism, of the first ingredient within the blending chamber.

The piston is moved to a first position with respect to the blending mechanism during a blending cycle. The piston is moved to a second position with respect to the blending mechanism during a dispensing cycle, the second position being closer to the blending mechanism than the first position. The piston is moved to a third position with respect to the blending mechanism during an introduction of a cleaning fluid into the blending chamber, the third position being farther away from the blending mechanism than the first position. The piston is moved to a fourth position with respect to the blending mechanism during a discharging of the cleaning fluid cycle.

A method of blending and dispensing a mixture meters a first ingredient into a blending chamber by weighing the first ingredient within the blending chamber; introduces a second ingredient into the blending chamber; moves a piston into position to engage the ingredients within the blending chamber; blends the ingredients using a rotating blade while the piston engages the ingredients; opens a dispensing mechanism, after expiration of a predetermined period of time; maintains the blending process while further moving the piston closer to the rotating blade to assist in dispensing the blended ingredients; moves the piston away from the rotating blade while introducing air into the blending chamber between the piston and the blended ingredients; moves the piston closer to the rotating blade to dispense a remainder of the blended ingredients; closes the dispensing mechanism and moving the piston away from the rotating blade; introduces a clean fluid into the blending chamber; agitates the cleaning fluid to clean the blending chamber and blade; and discharges the cleaning fluid from the blending chamber.

A system for blending and dispensing a mixture includes a blending chamber to receive ingredients to be blended; a blending mechanism including a rotating blade for blending and a motor to drive the blade; a piston, located within the blending chamber; a hollow shaft connected to the piston to cause the piston to move with the blending chamber, the hollow shaft having an air valve at an end opposite an end having the piston connected thereto; a dispensing mechanism to dispense a blended mixture from the blending chamber; a discharge mechanism to discharge a cleaning fluid from the blending chamber; a weighing mechanism for measuring a weigh of a first ingredient within the blending chamber; and a metering mechanism to meter the first ingredient in response the weight, measured by the weighing mechanism, of the first ingredient within the blending chamber.

The piston is moved to a first position with respect to the blending mechanism during a blending cycle. The piston is moved to a second position with respect to the blending mechanism during a dispensing cycle, the second position being closer to the blending mechanism than the first position. The piston is moved to a third position with respect to the blending mechanism during a dispensing cycle, the second position being closer to the blending mechanism than the third position.

The air valve is opened when the piston is moved to the third position to enable air to flow through the hollow shaft into the blending chamber.

The piston is moved to a fourth position with respect to the blending mechanism during a dispensing cycle, the fourth position being closer to the blending mechanism than the third position. The piston is moved to a fifth position with respect to the blending mechanism during an introduction of a cleaning fluid into the blending chamber, the fifth position being farther away from the blending mechanism than the fourth position. The piston is moved into a sixth position with respect to the blending mechanism during a discharging of the cleaning fluid cycle.

It will be appreciated that variations of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the description above and the following claims.

1. A method of blending and dispensing a mixture, comprising:
introducing ingredients into a blending chamber;
moving a piston into position to engage the ingredients within the blending chamber;
blending the ingredients using a rotating blade while the piston engages the ingredients;
opening a dispensing mechanism, after expiration of a predetermined period of time;
maintaining the blending process while further moving the piston closer to the rotating blade to assist in dispensing the blended ingredients;
closing the dispensing mechanism and moving the piston away from the rotating blade;
introducing a clean fluid into the blending chamber;
agitating the cleaning fluid to clean the blending chamber and blade; and
discharging the cleaning fluid from the blending chamber.

2. The method as claimed in claim 1, further comprising:
rotating the blade to agitate the cleaning fluid.

3. The method as claimed in claim 1, further comprising:
rotating the blade during the dispensing of the blended ingredients from the blending chamber.

4. The method as claimed in claim 1, further comprising:
moving the piston closer to the rotating blade during the agitation of the cleaning fluid.

5. The method as claimed in claim 4, further comprising:
moving the piston closer to the rotating blade during the discharging of the cleaning fluid.

6. The method as claimed in claim 1, further comprising:
moving the piston closer to the rotating blade during the discharging of the cleaning fluid.

7. The method as claimed in claim 1, wherein the blending chamber is cleaned by the cleaning fluid without being moved.

8. The method as claimed in claim 1, wherein the ingredients are metered into the blending chamber.

9. The method as claimed in claim 1, wherein one ingredient is weighed to enable proper metering of the ingredient into the blending chamber.

10. The method as claimed in claim 9, wherein the one ingredient is weighed outside the blending chamber to enable proper metering of the ingredient into the blending chamber.

11. The method as claimed in claim 9, wherein the one ingredient is weighed within the blending chamber to enable proper metering of the ingredient into the blending chamber.

12. The method as claimed in claim 1, wherein the cleaning fluid is discharged from the blending chamber through the dispensing mechanism.

13. The method as claimed in claim 12, further comprising positioning a drain under the dispensing mechanism when the cleaning fluid is discharged from the blending chamber.

14. The method as claimed in claim 12, further comprising positioning the dispensing mechanism over a drain when the cleaning fluid is discharged from the blending chamber.

15. The method as claimed in claim 12, further comprising positioning the dispensing mechanism over a discharge capture unit when the cleaning fluid is discharged from the blending chamber.

16. The method as claimed in claim 12, further comprising positioning a discharge capture unit under the dispensing mechanism when the cleaning fluid is discharged from the blending chamber.

17-141. (canceled)
